(19) United States
(12) Patent Application Publication
(10) Pub. No.: US 2003/0188930 A1
(43) Pub. Date: Oct. 9, 2003

(54) Roping configuration for traction machineroomless elevator

(76) Inventor: Richard Lauch, Hopatcong, NJ (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/115,805

(22) Filed: Apr. 4, 2002

(51) Int. Cl. B66B 11/08

(52) U.S. Cl. 187/264; 187/254; 187/266

(57) ABSTRACT

A traction-type elevator assembly includes an elevator car with a pair of secondary drive sheaves mounted below a floor of the car and connected for corotation by a common axle. The elevator assembly also includes a symmetrical roping configuration wherein a suspension rope has opposite ends anchored at a top of an elevator hoistway and extends on opposite sides of the car engaging the secondary drive sheaves. The rope engages a driving machine sheave, a turning sheave and a pair of diverting sheaves mounted in the hoistway, as well as engages a pair of counterweight sheaves for supporting a counterweight.

### BACKGROUND OF THE INVENTION

The present invention relates generally to roping configurations for elevators and, in particular, to a traction type machineroomless elevator assembly including a symmetrical roping configuration.

Elevators and their associated mechanical components are well known. Elevators are used to move people and equipment between floors in multistory buildings. A conventional traction type elevator installation includes an elevator car mounted in a car frame and moveable in a hoistway, a counterweight attached to the car frame via a rope, and a machine driving a traction or drive sheave that is engaged with the rope. As the machine turns the drive sheave, friction forces between the grooved surface of the sheave and the rope move the rope and thereby cause the car and counterweight to raise and lower in opposite directions.

The rope also can be routed through various turning or diverting sheaves when the drive sheave is not positioned directly above the car and the counterweight. The mechanical components of the elevator drive are generally located in a machine room, which room can be located at the top or bottom of the hoistway, or in a separate room to the side of the hoistway. Advances in elevator technology have led to the development of mini-machineroom or machineroomless (MMR/MRL) elevator installations. As their names imply, these types of elevator mechanical systems employ very small machine rooms or no machine rooms at all. These elevator applications, the MRL elevator applications in particular, have the goal of reducing the amount of building space occupied by the elevator systems and thereby increasing the amount of usable space on the floors. As these elevator installations become more common, a problem that arises with MRL elevator assemblies, however, is that the elevator car and counterweight must be suspended within the hoistway in a different manner than in prior art elevator installations having machine rooms.

It is desirable to eliminate the machine room of prior art elevator assemblies and provide a routing configuration for the suspension rope thereof while having the elevator drive and roping occupy as little space as possible within the hoistway.

It is also desirable to improve upon the configuration of the suspension rope, drive sheaves, and turning sheaves of traction-type elevators in order to increase the efficiency of and provide the optimum mechanical advantage for the mechanical components.

### SUMMARY OF THE INVENTION

The present invention concerns a novel arrangement and configuration for the mechanical components of a traction-type machine-room-less (MRL) elevator assembly. The elevator assembly according to the present invention includes an elevator car having a roof and a floor connected by a plurality of side walls disposed in an elevator shaft or hoistway. A driving machine is located in an upper portion of the elevator hoistway and to one side of the elevator car so that the elevator car is able to be next to the driving machine at a top floor. The driving machine includes a drive sheave rotatably attached thereto.

A pair of secondary drive sheaves is rotatably attached to the elevator car below the floor. An axle that extends underneath the elevator car floor directly connects the two secondary drive sheaves positioned on opposite sides of the car such that each secondary drive sheave will turn at the same speed and direction as the other. A counterweight is disposed on a rear side of the elevator car and is attached to a pair of counterweight sheaves. The suspension rope is anchored at both ends at a top portion of the hoistway and frictionally engages the drive sheave, the secondary drive sheaves and the counterweight sheaves.

The elevator assembly according to the present invention also includes a plurality of turning or diverting sheaves for directing the suspension rope from the drive sheave to the counterweight sheaves, and from the counterweight sheaves to one of the secondary drive sheaves. Furthermore, the suspension rope is advantageously routed along opposing sides of the elevator car in a symmetrical pattern.

The elevator assembly according to the present invention advantageously permits the placement of the drive machine at the top of the hoistway next to the car at the top floor, allowing for a MRL elevator installation.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of an elevator installation in accordance with the present invention.

### DESCRIPTION OF THE PREFERRED EMBODIMENT

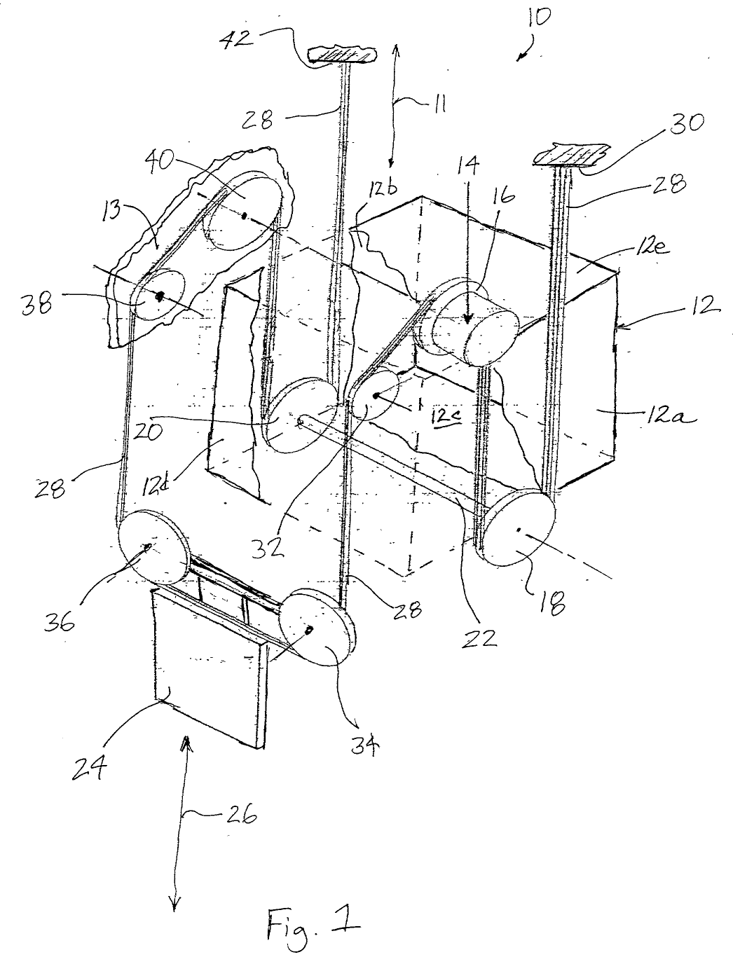

Referring now to FIG. 1, an elevator installation in accordance with the present invention is indicated generally at 10. The elevator installation 10 includes an elevator car 12 shown partially cut away for a better view of the associated roping configuration. The elevator car 12 is disposed in an elevator hoistway 13 and is operable to move along a vertical elevator travel path as indicated by an arrow 11. A driving machine 14, in the form of an electric motor, is mounted in the hoistway 13 and is coupled to rotate a primary traction or drive sheave 16. The machine 14 and the primary sheave 16 are mounted in the hoistway 13 to one side of the elevator car 12 so that the elevator car is able move next to the machine at a top floor (not shown) accessible to the hoistway.

A first secondary drive sheave 18 is rotatably mounted on the car 12 at a bottom of a side wall 12a. A second secondary drive sheave 20 is rotatably mounted on the car 12 at a bottom of a side wall 12b opposite the side wall 12a. The secondary drive sheaves 18 and 20 are coupled for corotation by an axle 22 that extends beneath a floor 12c of the car 12 such that the secondary drive sheaves are operable to rotate at the same speed and direction during movement of the elevator car. The secondary drive sheaves 18 and 20, and the drive sheave 16 all include circumferential grooves (not shown) formed thereon for engaging a suspension rope, outlined in more detail below. A counterweight 24 is disposed in the hoistway 13 and is operable to move along a counterweight travel path indicated by an arrow 26 extending parallel to the elevator car travel path 11. During operation of the elevator installation 10, the counterweight 24 and the elevator car 12 pass one another travelling in opposite directions such that the counterweight is adjacent a rear wall 12d of the car.

The walls 12a, 12b and 12d are attached to the floor 12c and to a roof 12e of the elevator car 12. Subject to the spacing between an entrance to the top floor and a top of the hoistway 13, the axle 22 and the secondary drive sheaves 18 and 20 can be mounted on the roof 12e.

At least one suspension rope 28 has one end attached to an anchorage 30 at the top of the hoistway. From the anchorage 30, the suspension rope 28 extends downwardly and wraps under the first secondary drive sheave 18 to engage a portion of the sheave groove. The suspension rope 28 then extends upwardly from the sheave 18 to wrap over the drive sheave 16 on the driving machine 14. The suspension rope 28 further extends downwardly and rearwardly from the sheave 16 to pass over a first turning or diverting sheave 32 rotatably mounted in the hoistway near the driving machine 14. The sheaves 16, 18 and 32 lie in the same vertical plane. The rope 28 extends downwardly from the sheave 32 to wrap under a first counterweight sheave 34 and a second counterweight sheave 36 rotatably attached to the counterweight 24 adjacent to opposite side edges of the counterweight. The counterweight sheaves 34 and 36 lie in a plane that is perpendicular to the plane of the sheaves 16, 18 and 32.

From the second counterweight sheave 36, the suspension rope 28 extends upwardly over a second turning or diverting sheave 38 rotatably mounted in the hoistway opposite the first turning sheave 32. The suspension rope 28 extends upwardly and forwardly from the sheave 38 to wrap over a third turning sheave 40 rotatably mounted in the hoistway opposite the sheave 16. The suspension rope 28 then extends downwardly to wrap under the second secondary drive sheave 20. Finally, the rope 28 extends upwardly where an opposite end is attached to a second anchorage 42 in the hoistway.

The weight of the elevator car 12 and the weight of the counterweight 24 are supported by the rope 28 to cause frictional engagement with the drive sheave 16 whereby the rotation of the motor 14 causes movement of the car along the path 11 and movement in an opposite direction of the counterweight along the path 26. Because of the symmetrical placement of the secondary drive sheaves 18 and 20, the driving sheave 16 and the third turning sheave 40, and the turning sheaves 32 and 38 within the hoistway, the suspension rope 28 is advantageously arranged in a symmetrical pattern on opposite sides of the elevator car 12. By connecting the secondary drive sheaves 18 and 20 with the axle 22 for co-rotation, the driving force is distributed both sides of the car 12 and the counterweight 24 for smoother operation.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator car assembly for use in a traction-type elevator installation comprising:
an elevator car having a pair of opposed side walls with a floor and a roof extending between and attached to said side walls;
an axle mounted on said car and having opposed ends, each of said axle ends extending beyond an associated one of said side walls; and
a pair of secondary drive sheaves each adapted to frictionally engage a suspension rope of an elevator installation, each of said secondary drive sheaves being attached to an associated one of said axle ends for corotation of said secondary drive sheaves.

2. The elevator car assembly according to claim 1 including a driving machine having a rotatable primary drive sheave mounted at one side of an elevator hoistway adjacent a travel path of said elevator car, a turning sheave rotatably mounted on another side of the elevator hoistway opposite said driving machine, and a suspension rope having opposite ends connected to anchorages at a top of the hoistway, said suspension rope extending downwardly from said anchorages adjacent said side walls, wrapping under said secondary drive sheaves, extending upwardly from said secondary drive sheaves and wrapping over said primary drive sheave and said turning sheave to support said elevator car in the hoistway.

3. The elevator car assembly according to claim 2 including a counterweight and at least one counterweight sheave rotatably attached to said counterweight, said one counterweight sheave engaging said suspension rope for movement in the hoistway in a direction opposite a direction of movement of said elevator car.

4. The elevator car assembly according to claim 3 including a pair of diverting sheaves rotatably mounted in the hoistway and engaging said suspension rope between said primary drive sheave and said one counterweight sheave and engaging said suspension rope between said turning sheave and said one counterweight sheave.

5. The elevator car assembly according to claim 1 including a counterweight and at least one counterweight sheave rotatably attached to said counterweight, said counterweight sheave engaging said suspension rope for movement in the hoistway in a direction opposite a direction of movement of said elevator car.

6. The elevator car assembly according to claim 1 wherein said axle is mounted beneath said floor of said elevator car.

7. An elevator installation including a traction-type elevator car travelling in an elevator hoistway comprising:
an elevator car having a pair of opposed side walls with a floor and a roof extending between and attached to said side walls, said elevator car being positioned in an elevator hoistway;
an axle mounted on said car and having opposed ends, each of said axle ends extending beyond an associated one of said side walls;
a pair of secondary drive sheaves each adapted to frictionally engage a suspension rope of an elevator installation, each of said secondary drive sheaves being attached to an associated one of said axle ends for corotation of said secondary drive sheaves;
a driving machine having a rotatable primary drive sheave mounted at one side of the elevator hoistway adjacent a travel path of said elevator car;
a turning sheave rotatably mounted on another side of the elevator hoistway opposite said driving machine;
a pair of diverting sheaves rotatably mounted in the elevator hoistway adjacent said driving machine and said turning sheave;
a counterweight positioned in the hoistway;
a pair of counterweight sheaves rotatably attached to said counterweight; and
a suspension rope having opposite ends connected to anchorages at a top of the hoistway, said suspension rope extending downwardly from said anchorages adjacent said side walls of said elevator car, wrapping under said secondary drive sheaves, extending upwardly from said secondary drive sheaves and wrapping over said primary drive sheave and said turning sheave to support said elevator car in the hoistway, extending to and wrapping over said diverting sheaves, and extending downwardly to and engaging said counterweight sheaves for supporting said counterweight whereby movement of said elevator car in the hoistway in one direction causes said counterweight to move in an opposite a direction.

8. The elevator car assembly according to claim 7 wherein said axle is mounted beneath said floor of said elevator car.

9. An elevator installation comprising:
an elevator hoistway having an elevator car disposed therein, said elevator car having a floor connected between a pair of side walls;
a driving machine mounted in said hoistway and having a primary driving sheave;
a turning sheave rotatably mounted in said hoistway on an opposite side of a path of travel of said elevator car;
an axle mounted on said elevator car;
a pair of secondary drive sheaves attached to opposite sides of said axle for corotation;
a counterweight disposed in said hoistway; and
at least one suspension rope having opposite ends anchored to a top portion of said hoistway, said suspension rope frictionally engaging said driving sheave, said turning sheave and each of said secondary drive sheaves in a symmetrical configuration, said suspension rope further being attached to said counterweight.
